(19) United States
(12) Patent Application Publication
(10) Pub. No.: US 2020/0300136 A1
(43) Pub. Date: Sep. 24, 2020

(54) METHOD OF SELECTING AN OPERATING MODE OF AN ACTIVE SOUND GENERATING DEVICE OF AN EXHAUST SYSTEM, EXHAUST SYSTEM, AND MOTOR VEHICLE

(71) Applicant: Faurecia Emissions Control Technologies, Germany GmbH, Augsburg (DE)

(72) Inventors: Dennis BREUER, Augsburg (DE); Hoi-Jeon KIM, Augsburg (DE)

(21) Appl. No.: 16/820,914

(22) Filed: Mar. 17, 2020

(30) Foreign Application Priority Data
Mar. 19, 2019 (DE) 10 2019 107 044.9

(51) Int. Cl. F01N 1/06; F01N 1/02; G07C 5/08; G06K 9/00

(52) U.S. Cl. CPC F01N 1/065; G06K 9/00791; G07C 5/0816; F01N 1/02

(57) ABSTRACT

A method of selecting an operating mode of an active sound generating device of an exhaust system for a motor vehicle includes acquiring information on the operation of the motor vehicle and/or information on the environment of the motor vehicle. On this basis, one of at least two predefined operating modes of the active sound generating device is selected. The selected operating mode or an operating mode to be selected in the future is displayed for the driver. Alternatively or additionally, a characteristic value associated with the selected operating mode or the operating mode to be selected in the future is displayed for the driver. Furthermore, an associated exhaust system and a motor vehicle equipped therewith are described.

### CROSS-REFERENCE TO RELATED APPLICATIONS

This application is a U.S. non-provisional application claiming the benefit of German Application No. 10 2019 107 044.9, filed on Mar. 19, 2019, which is incorporated herein by its entirety.

### TECHNICAL FIELD

The disclosure relates to a method of selecting an operating mode of an active sound generating device of an exhaust system for a motor vehicle, the exhaust system comprising at least one exhaust pipe carrying exhaust gas and an active sound generating device configured to generate sound waves that interact with the exhaust gas carried in the exhaust pipe, an information being acquired on the operation of the motor vehicle, in particular on the operation of an internal combustion engine of the motor vehicle, and/or an information being acquired on the environment of the motor vehicle, and one of at least two predefined operating modes of the active sound generating device being selected on the basis of the information acquired.

The interaction of the sound waves emanating from the sound generating device with the exhaust gas carried in the exhaust pipe can be effected in two variants here. According to a first variant, the interaction takes place inside the exhaust pipe. To this end, the sound waves are directed into the interior of the exhaust pipe. The acoustic superposition of the sound waves carried by the exhaust gas flow and the sound waves emanating from the sound generating device thus takes place inside the exhaust pipe. In a second variant, the interaction takes place outside the exhaust pipe. This means that the sound waves carried by the exhaust gas flow and the sound waves generated by the sound generating device are acoustically superposed outside the exhaust pipe. In particular, an area around an environment-side end of the exhaust pipe, which is also referred to as tailpipe, comes into consideration for this purpose. The advantage of a sound generating device arranged in accordance with the second variant is that it is not directly impinged on by high-temperature exhaust gases.

The disclosure furthermore relates to an exhaust system for a motor vehicle, including at least one exhaust pipe carrying exhaust gas and an active sound generating device configured to generate sound waves that interact with the exhaust gas carried in the exhaust pipe, the sound generating device having at least two different operating modes, the sound generating device including a drive interface, via which the sound generating device is connectable, in terms of signaling, to a control unit of a drive engine of the motor vehicle, the sound generating device including an environment interface, via which the sound generating device is directly or indirectly connectable, in terms of signaling, to at least one sensor which detects an environment of the motor vehicle, and an operating mode of the sound generating device being selectable by a control unit of the active sound generating device taking into account a signal provided at the drive interface and/or the environment interface.

The disclosure further relates to a motor vehicle including an internal combustion engine which is coupled to an exhaust system of the above-mentioned type.

### BACKGROUND

Such methods, exhaust systems, and motor vehicles are known from the prior art.

Active sound generating devices are utilized here, on the one hand, to attenuate sound emitted by the internal combustion engine of the motor vehicle, so that less sound emanating from the motor vehicle is radiated into an environment thereof. On the other hand, active sound generating devices are also made use of for a so-called sound design. In this context, the sound originating from the internal combustion engine of the motor vehicle and carried by the exhaust gas flow is selectively attenuated, i.e. in specific frequency bands, and/or supplemented by sound generated by the active sound generating device, so that the combination of the sound generated by the active sound generating device and the sound carried by the exhaust gas flow results in a sound impression or pattern desired and/or perceived as pleasant by a user of the motor vehicle. In this case, the active sound generating device is frequently referred to as a sound generator.

The information on the operation of the motor vehicle and/or the information on the environment of the motor vehicle may, for example, be a sound information which is captured by a microphone coupled to the active sound generating device. This information may also be a position of the motor vehicle and/or a date or time information. Furthermore, the active sound generating device may be coupled to the engine control unit.

Known methods of the type initially mentioned as well as associated exhaust systems and motor vehicles always operate in an area of conflicting interests which is determined, on the one hand, by the fact that sound emanating from motor vehicles is perceived as disturbing in many places and in many situations. This is the case, for example, in residential areas or near busy inner-city streets. In such places there is a high need for quiet, in particular at night. On the other hand, a sound emanating from the internal combustion engine and carried by the exhaust gas flow constitutes an important characteristic of the motor vehicle and/or of the internal combustion engine for many vehicle users. The sound involved is perceived as pleasant or appealing. There is therefore a conflict between those vehicle users who are pleased to hear the sound originating from their motor vehicles and possibly other motor vehicles as well, and other persons who would like to avoid such sound.

Improvements for selecting an operating mode of an active sound generating device of an exhaust system for a motor vehicle as well as associated exhaust systems and motor vehicles are needed in view of this conflict.

### SUMMARY

A method is provided, in which the selected operating mode or an operating mode, to be selected in the future, of the active sound generating device is displayed for the driver, and/or a characteristic value associated with the selected operating mode or the operating mode, to be selected in the future, of the active sound generating device is displayed for the driver. In this context, the definition of characteristic value is to be understood in a broad sense. It may involve an alphanumeric value or a graphical display. For example, such a value represents a limit value of a noise emission, a speed limit, or indicates that the vehicle is in an area with a high need for quiet, e.g. in the surroundings of a hospital. A time of day or night may also be displayed. Also, the characteristic value may be a level of a fine that is incurred if, e.g., a driver drives into an area using the wrong operating mode, or the noise emission is too high. Furthermore, the characteristic value may also be represented in the form of a traffic light display which only reflects whether or not the active sound generating device is in a permissible or approved operating mode which, for example, meets external limit values. The display of the selected operating mode or the operating mode to be selected in the future and/or an associated characteristic value makes it easier for the driver to always select an appropriate operating mode of the active sound generating device. In the event that external requirements exist with respect to the operating mode, this will be displayed to the driver, who can react thereto quickly and with little effort. If there are no such requirements, this will also be displayed to the driver, who can then select an operating mode that suits his or her personal preferences. This allows the active sound generating device to be operated in a reliable and simple manner in the area of opposing interests of the conflict described above.

Likewise a method is provided, in which communication takes place with a unit external to the motor vehicle, in particular an infrastructure unit, wherein an information on a state of the motor vehicle, in particular on the selected operating mode of the active sound generating device, is transmitted to the unit external to the motor vehicle, and/or a limit value information is transferred to the motor vehicle from the unit external to the motor vehicle. That is, communication can be effected from the motor vehicle towards the unit external to the motor vehicle or vice versa, i.e. from the unit external to the motor vehicle towards the motor vehicle. A combination of these variants, that is, in which communication takes place in both directions, is also possible. Transmitting an information from the motor vehicle to the unit external to the motor vehicle is carried out here with the purpose that the unit external to the motor vehicle can check whether the motor vehicle is operated taking into consideration all requirements and rules and regulations, in particular with a view to sound emission. The information transmitted from the motor vehicle to the unit external to the motor vehicle may also comprise a request for operational release, to which the unit external to the motor vehicle will, in a positive case, respond with such a release and, in a negative case, will cause an automated sanction or place the motor vehicle in an approved operating condition in an automated manner, which includes in particular an approved operating mode of the active sound damping device. Similarly, the information sent by the motor vehicle to the unit external to the motor vehicle may comprise a request for information, that is, an inquiry for a particular characteristic value or a particular information. Subsequently, an appropriate change in the operating mode can be made in an automated manner or manually. Optionally, to this end, the usable operating modes can also be displayed to a motor vehicle user. The limit values transmitted by the unit external to the motor vehicle relate, in particular, to the sound emission. In this case, the limit value constitutes a sound limit value information. However, limit values which have an indirect effect on the sound emission, e.g. speed limits, are just as conceivable. This may be done in a zone- or position-dependent manner With respect to the limit value information, a distinction may also be made between private motor vehicles and official motor vehicles, e.g. police cars, fire engines or ambulances. Thus, different limit values can be provided and communicated for different types of motor vehicles. Consequently, it can be ensured in a simple and reliable way that the above-mentioned conflicting requirements are taken into account. The active sound generating device can therefore be operated without any difficulty in the area of conflicting interests described.

The methods according to the disclosure are suitable for use with both variants, initially mentioned, of the interaction of the sound waves emanating from the sound generating device with the exhaust gas carried in the exhaust pipe. This means that in connection with the methods according to the disclosure, the superposition of the sound waves can occur either inside the exhaust pipe or outside the exhaust pipe. In the event that the superposition of the sound waves takes place outside the exhaust pipe, the methods according to the disclosure are particularly well suited for retrofittable exhaust system components, in particular retrofittable sound generating devices.

The motor vehicle communicates with the unit external to the motor vehicle preferably wirelessly, in particular by radio or optically.

The unit external to the motor vehicle is preferably a part of a so-called smart city. It may be a measurement or release station. It is also possible that the unit external to the motor vehicle is a traffic sign that is read out by the motor vehicle in an automated manner. The unit external to the motor vehicle may also be an intelligent or smart traffic sign, which, compared with a standard traffic sign, is extended by a method for transmitting information, which operates by radio, for example.

In one variant, a limit value information transferred to the motor vehicle from the unit external to the motor vehicle and/or an information derived therefrom is displayed to the driver. This means that the driver is informed through the limit value information itself or an information derived therefrom, which may possibly be more relevant to the driver or easier for him/her to interpret. In this connection, for example, a speed limit may be displayed to the driver, or he/she may be notified that he/she is currently driving on a play street. In this context, a speed limit may also be an information derived from a limit value for a sound emission, for example. In fact, it is considerably easier for a driver to comply with a speed limit than with a predefined maximum sound level.

According to one embodiment, a preference of a motor vehicle user for an operating mode of the active sound generating device is additionally taken into account when selecting the operating mode of the active sound generating device. A motor vehicle user may prefer one or more operating modes over the other operating modes of the active sound generating device. In the event that the sound generating device has more than two operating modes, the preferences of the motor vehicle user may also take the form of a hierarchy of the operating modes. The operating mode of the sound generating device is thus selected such that, taking into account any possibly specified limit values or constraints, that operating mode which best matches the preference of the motor vehicle user is selected.

The preference of the motor vehicle user may be set manually here. This means that the motor vehicle user manually sets a preferred operating mode or a certain hierarchy of the operating modes. Alternatively, a preference of the motor vehicle user may also be detected automatically. This is possible, on the one hand, using a driver's profile stored on the motor vehicle and, on the other hand, by acquiring and storing settings made by the motor vehicle user. Using the data basis thus generated, the preferences of the motor vehicle user can then be determined and set. This is done, for example, by automatically setting that operating mode of the active sound generating device which the motor vehicle user has used during most of his or her journeys.

Alternatively or additionally, it is possible that the information on the environment of the motor vehicle includes at least one camera image captured by a vehicle-mounted camera and/or at least one information captured by a vehicle-mounted camera and provided by a traffic sign. By using a vehicle-mounted camera, an environment of the motor vehicle beyond the traffic signs can be captured in the form of a camera image. This image can be evaluated in an automated manner, so that it can be determined, for example, whether the motor vehicle is in a residential area or in a commercial area. Also, it can be determined in this way how many pedestrians and/or cyclists are in the vicinity of the motor vehicle. The active sound generating device can then be placed in an operating mode that is suited to this environment.

Capturing the information on the environment of the motor vehicle by use of a camera constitutes only one of a plurality of possible alternatives here. Instead of a camera, an environment detection system can generally be used. This may comprise a camera, LIDAR, LADAR, radar and/or ultrasonic sensors.

According to one embodiment, one of the operating modes of the active sound generating device is a sound suppression mode, in which a sound carried by the exhaust gas is at least partly cancelled out, preferably completely cancelled out, by the sound of the active sound generating device, and/or one of the operating modes of the active sound generating device is an imitation mode, in which a sound carried by the exhaust gas is influenced to the effect that a resultant total sound equals or corresponds to an imitation target, and/or one of the operating modes of the active sound generating device is a warning mode, in which a warning noise is added to a sound carried by the exhaust gas. The total sound here is understood to mean the sound that results from a superposition of the sound emanating from the internal combustion engine of the motor vehicle and carried by the exhaust gas flow and the sound generated by the active sound generating device. The sound suppression mode may also be referred to as noise cancellation mode. Another designation for the imitation mode is “sound to target”. In this connection, the imitation target may be the noise of a six-cylinder engine or an eight-cylinder engine, for example. The warning mode may also be called sound generation mode. It serves the safety of persons who are in the immediate vicinity of the motor vehicle, which, for example, is currently performing a parking maneuver. In a broader sense, an additional operating mode is also the switched-off mode of the sound generating device and an optional stand-by mode.

The information on the operation of the motor vehicle and/or the information on the environment of the motor vehicle may be continuously acquired in a specified time cycle. This means that it is checked in each time cycle whether this information has changed and therefore a different operating mode should or can possibly be selected. In this way, it is ensured that the active sound generating device is in a suitable operating mode at all times.

The information on the operation of the motor vehicle may comprise an information on the travel speed of the motor vehicle, that is, a travel speed information. Alternatively or additionally, the information on the operation of the motor vehicle comprises an information on the operating noise emitted by the motor vehicle, that is, a sound information. It is also possible that the information on the operation of the motor vehicle comprises an information on the operating location of the motor vehicle and/or an information on the operating time of the motor vehicle. The above-mentioned information can be taken into account when selecting one of the at least two predefined operating modes. A suitable operating mode can thus be selected at all times.

The information on the operation of the internal combustion engine may comprise an information on the speed of the internal combustion engine, an information on the torque output by the internal combustion engine, and/or an information on the power output by the internal combustion engine. This information may also be used to select a suitable operating mode.

Advantageously, different types of information on the operation of the motor vehicle and/or different types of information on the environment of the motor vehicle each have a priority value assigned thereto, so that when information is acquired that is inconsistent with regard to the operating mode to be selected of the active sound generating device, the operating mode is always selected on the basis of that information that has the higher priority value. Such prioritization may, for example, be prescribed by legislation or may be specified by a vehicle user. In this way it is ensured that the most suitable operating mode is always selected.

In addition, an exhaust system is provided, wherein a display device is provided for a driver of the motor vehicle, on which a currently selected or a future operating mode of the active sound generating device and/or a characteristic value associated with the currently selected or future operating mode of the active sound generating device is/are displayable. In this way, the effects and advantages mentioned with respect to the method of selecting an operating mode of an active sound generating device can be achieved.

Preferably, one or more of the operating modes already mentioned are provided, namely a sound suppression mode and/or an imitation mode and/or a warning mode. The effects and advantages will result in accordance with the foregoing discussions.

Advantageously, such an exhaust system includes a control unit which checks the signal inputs at regular intervals and selects the correct operating mode on the basis of the signals applied there.

The exhaust system may also include a prioritization unit, which serves to handle signals that would influence the operating mode of the active sound generating device in a contradictory or inconsistent manner. To this end, the prioritization unit has a kind of hierarchy of the signals stored therein, from which it is apparent which one of the signals for determining the operating mode is to be considered dominant, thus dictating the operating mode. Such prioritization may, for example, be prescribed by the legislator or determined by the user of the motor vehicle. Combinations are also possible.

Furthermore, an exhaust system includes a communication interface via which an information on a state of the motor vehicle, in particular on the selected operating mode, can be transmitted to a unit external to the motor vehicle, in particular an infrastructure unit, and/or via which a limit value information can be transferred from the unit external to the motor vehicle, in particular an infrastructure unit, to the motor vehicle. The effects and advantages already mentioned in connection with the method of selecting an operating mode of an active sound generating device will result.

According to one embodiment, a limit value information transferred to the motor vehicle from the unit external to the motor vehicle and/or an information derived therefrom is/are displayable on the display device for the driver. As a result, the driver is always informed of the limit value information and/or an information derived therefrom and can select a suitable operating mode of the active sound generating device in the area of conflicting interests initially defined.

Furthermore, an input device may be provided, by preferences in regard to the selection of the operating mode can be entered, in particular wherein the display device and the input device are realized as one single, combined device. Reference is made to the foregoing discussions on taking preferences of the vehicle user into account. A combined device is a touch display, for example.

In one variant, a camera is coupled to the environment interface in terms of signaling, and the information on the environment of the motor vehicle is detectable by the camera. Using this camera, the environment of the motor vehicle can be captured as a camera image and then be evaluated in an automated manner. Also, it is possible to read out traffic signs in an automated manner by use of the camera. This results in the effects and advantages already discussed in regard to the method.

Preferably, the active sound generating device is in the form of an active sound damper, a sound generator, or a combination thereof. This allows numerous operating modes to be realized, from sound damping to sound design. Consequently, an appropriate operating mode can be provided for different requirements.

The exhaust system according to the disclosure can provide for both variants initially mentioned of the interaction between the sound waves emanating from the sound generating device and the exhaust gas carried in the exhaust pipe. This means that in connection with the exhaust system according to the disclosure, the superposition of the sound waves can be effected either inside the exhaust pipe or outside the exhaust pipe. In the event that the superposition of the sound waves takes place outside the exhaust pipe, the exhaust system according to the disclosure is in particular configured as a retrofit solution.

Furthermore, a motor vehicle is provided with the internal combustion engine being coupled to an exhaust system according to the disclosure. The effects and advantages already discussed in relation to the exhaust system apply analogously to the motor vehicle.

### DESCRIPTION OF THE DRAWINGS

The disclosure will now be discussed below with reference to an exemplary embodiment which is shown in the accompanying drawings, in which:

FIG. 1 shows a motor vehicle according to an exemplary disclosure, including an exhaust system according to an exemplary disclosure and having an active sound generating device, the operating mode of which is selected via a method according to an exemplary disclosure;

FIG. 2 shows the exhaust system according to FIG. 1 in a schematic overview; and

FIG. 3 schematically shows the flow of the method according to the disclosure.

### DESCRIPTION

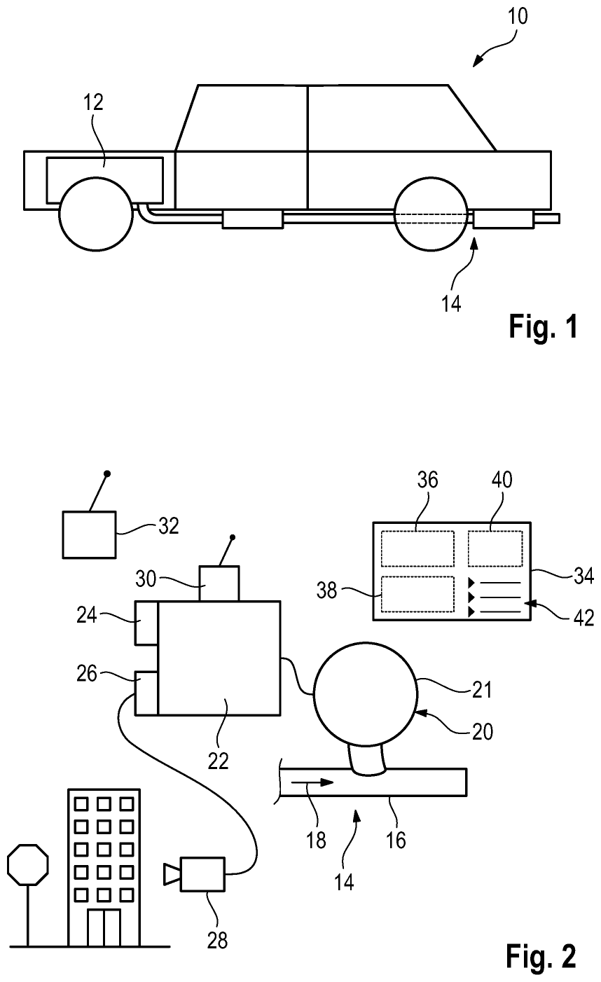

FIG. 1 shows a motor vehicle 10 which is equipped with an internal combustion engine 12 that serves as a drive engine.

As shown in FIG. 2, the internal combustion engine 12 is coupled to an exhaust system 14, which comprises at least one exhaust pipe 16 carrying exhaust gas. An exhaust gas flow existing there is schematically symbolized by the arrow 18.

The exhaust system 14 further includes an active sound generating device 20, which is configured to generate sound waves that interact with the exhaust gas carried in the exhaust pipe 16 (cf. arrow 18).

The sound generating device 20 is coupled to the exhaust pipe 16 only by way of example here. A sound generating device that is arranged beside the exhaust pipe 16 so that the sound waves generated by the sound generating device are superimposed with the sound waves carried by the exhaust gas flow (arrow 18) outside the exhaust pipe 16 is also conceivable.

In the illustrated example, the active sound generating device 20 comprises a loudspeaker which is arranged inside the housing 21 and used for generating the aforementioned sound waves. In this context, the active sound generating device 20 can act both as an active sound damper, which damps a sound carried by the exhaust gas flow in the exhaust pipe 16, and as a so-called sound generator. In this connection, a sound generated by the active sound generating device 20 supplements the sound carried by the exhaust gas flow in the exhaust pipe 16, so that a total sound having specified characteristics is produced.

The active sound generating device 20 further includes a control unit 22, by which an operating mode of the active sound generating device 20 can be set.

In the illustrated exemplary embodiment, the active sound generating device 20 has three different operating modes.

A first operating mode here is a sound suppression mode, in which a sound carried by the exhaust gas is preferably completely cancelled out by the sound generated by the active sound generating device 20.

A second operating mode is a so-called imitation mode. In this mode, a sound carried by the exhaust gas is influenced to the effect that a resultant total sound equals or corresponds to an imitation target. In this way, for example, a total sound can be set that corresponds to the sound of a six-cylinder engine, irrespective of the number of cylinders of the internal combustion engine.

A third operating mode is a warning mode. In this mode, the sound carried by the exhaust gas is supplemented by a warning noise that alerts other road users to the presence and/or movement of the motor vehicle 10.

The sound generating device 20, more precisely the control unit 22, further includes a plurality of interfaces.

The sound generating device 20 can be connected in terms of signaling to a control unit of a drive engine or drive motor of the motor vehicle 10 via a drive interface 24. In the present case, the internal combustion engine 12 is the drive engine.

Furthermore, an environment interface 26 is provided, via which the sound generating device 20 is directly or indirectly connectable, in terms of signaling, to at least one sensor which detects an environment of the motor vehicle 10.

In the illustrated embodiment, a camera 28 is coupled to the environment interface 26 in terms of signaling, so that information on the environment of the motor vehicle 10 is captured by the camera 28. LIDAR, LADAR, radar and/or ultrasonic systems are also conceivable as an alternative or in addition to the camera.

Additionally, the control unit 22 includes a communication interface 30, via which an information on a state of the motor vehicle 10, in particular on the selected operating mode, can be transmitted to a unit 32 external to the motor vehicle, which in the present case is an infrastructure unit. In addition, a limit value information can be transferred from the unit external to the motor vehicle via the communication interface 30 to the motor vehicle 10, more precisely to the control unit 22.

In addition, a display device 34 is provided for the driver of the motor vehicle 10, on which a currently selected operating mode of the active sound generating device 20 can be displayed in an area 36. An operating mode to be selected in the future can also be depicted in an area 38. Furthermore, characteristic values that relate to the currently selected or the future operating mode may also be displayed in the areas 36, 38.

Moreover, limit value information or information derived therefrom which is transferred to the motor vehicle 10 from the unit 32 external to the motor vehicle can be displayed in an area 40.

In the present case, the display device 34 also doubles as an input device. Thus, the display device 34 can be used to enter preferences of the driver regarding the operating mode to be selected. An area 42 is provided for this. This means that the driver can indicate, for example, that he prefers the imitation mode over the sound suppression mode and the warning mode if a sporty and emotionally appealing sound of his motor vehicle 10 is important to him.

For example, the display device 34 comprises a touch display.

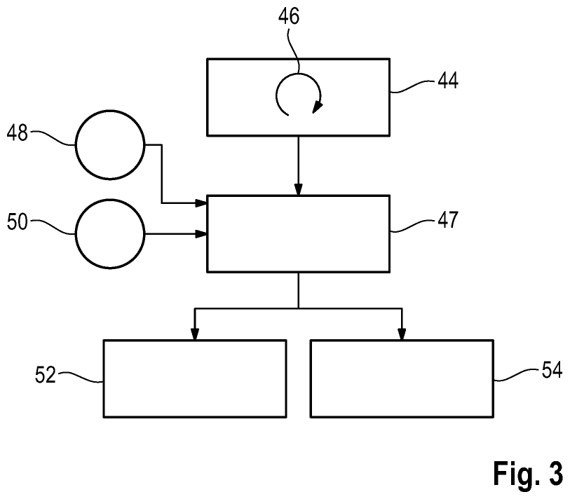

The operating mode of the sound generating device 20 is selected by the control unit 22 taking into account signals provided at the drive interface 24 and the environment interface 26. The sequence or flow of the associated method of selecting the operating mode of the active sound generating device 20 is illustrated in detail in FIG. 3.

In a first step 44, an information on the operation of the motor vehicle 10, in this case on the operation of the internal combustion engine 12, is acquired via the drive interface 24.

In addition, an information on the environment of the motor vehicle 10 is provided via the environment interface 26. As already discussed, the environment interface 26 is connected to the camera 28. The information on the environment of the motor vehicle 10 is thus available in the form of a camera image. Furthermore, traffic signs can be captured by the camera 28. In this way, information provided by traffic signs can also be taken into account.

The above-mentioned information provided via the drive interface 24 and the environment interface 26 is continuously acquired in a specified time cycle. This is illustrated by arrow 46. Changes in the information provided via the drive interface 24 and the environment interface 26 are thus reliably detected and can be included in the selection of the operating mode.

In a second step 47, the selection of one of the predefined operating modes of the active sound generating device 20, which were already discussed, is carried out.

The selection is made here on the basis of the information acquired in the first step 44.

In the event that in the first step 44, information is acquired which is inconsistent with regard to the operating mode to be selected of the active sound generating device 20, a priority value 48 is assigned to each information acquired in the first step 44. The pieces of information acquired in the first step 44 are thus hierarchized, so that no inconsistencies can occur when selecting the operating mode of the active sound generating device 20.

In addition, when selecting the operating mode, preferences 50 of a motor vehicle user for an operating mode of the active sound generating device 20 are also taken into account.

Subsequent to the second step 47, in step 52, the selected operating mode, or an operating mode to be selected in the future, of the active sound generating device 20 can be displayed for the driver on the display device 34. As already discussed, associated characteristic values can also be displayed as part of step 52.

Alternatively or in addition to step 52, a step 54 may be carried out. A communication of the motor vehicle 10 with the unit 32 external to the motor vehicle takes place here. In this connection, an information on the state of the motor vehicle 10, in particular on the selected operating mode of the active sound generating device 20, is sent to the unit 32 external to the motor vehicle. Also, as already discussed, a limit value information may be transferred from the unit 32 external to the motor vehicle to the motor vehicle 10.

On the basis of the information communicated, a motor vehicle user, the motor vehicle 10 and/or the unit 32 external to the motor vehicle can then make a decision as to whether the currently set operating mode is retained or a different operating mode is selected.

The limit value information transferred from the unit 32 external to the motor vehicle to the motor vehicle 10 and/or information derived therefrom may also be displayed on the display device 34.

Although various embodiments have been disclosed, a worker of ordinary skill in this art would recognize that certain modifications would come within the scope of this disclosure. For that reason, the following claims should be studied to determine the true scope and content of this disclosure.

1. A method of selecting an operating mode of an active sound generating device) of an exhaust system for a motor vehicle, the exhaust system comprising at least one exhaust pipe carrying exhaust gas and an active sound generating device configured to generate sound waves that interact with the exhaust gas carried in the at least one exhaust pipe, comprising the steps of:
(a) acquiring an information on an operation of the motor vehicle, in particular on the operation of an internal combustion engine of the motor vehicle, and/or acquiring an information on an environment of the motor vehicle;
(b) selecting one of at least two predefined operating modes of the active sound generating device on a basis of information acquired in step (a); and
(c) displaying a selected operating mode or an operating mode, to be selected in the future, of the active sound generating device for the driver, and/or displaying a characteristic value associated with the selected operating mode or the operating mode, to be selected in the future, of the active sound generating device for the driver.

2. The method according to claim 1 including:
communicating with a unit external to the motor vehicle, in particular an infrastructure unit, wherein an information on a state of the motor vehicle, in particular on the selected operating mode of the active sound generating device), is transmitted to the unit external to the motor vehicle, and/or a limit value information is transferred to the motor vehicle from the unit external to the motor vehicle.

3. The method according to claim 2, wherein a limit value information transferred to the motor vehicle from the unit external to the motor vehicle and/or an information derived therefrom is displayed to the driver.

4. The method according to claim 1, wherein a preference of a motor vehicle user for an operating mode of the active sound generating device is additionally taken into account when selecting the operating mode of the active sound generating device.

5. The method according to claim 1, wherein the information on the environment of the motor vehicle comprises at least one camera image captured by a vehicle-mounted camera and/or at least one information captured by a vehicle-mounted camera and provided by a traffic sign.

6. The method according to claim 1, wherein
one of the operating modes of the active sound generating device is a sound suppression mode, in which a sound carried by the exhaust gas is at least partly cancelled out, preferably completely cancelled out, by the sound of the active sound generating device, and/or
one of the operating modes of the active sound generating device is an imitation mode, in which a sound carried by the exhaust gas is influenced to the effect that a resultant total sound equals or corresponds to an imitation target, and/or
one of the operating modes of the active sound generating device is a warning mode, in which a warning noise is added to a sound carried by the exhaust gas.

7. The method according to claim 1, characterized in wherein the information on the operation of the motor vehicle) and/or the information on the environment of the motor vehicle is/are continuously acquired in a specified time cycle.

8. The method according to claim 1, wherein the information on the operation of the motor vehicle comprises an information on a travel speed of the motor vehicle, an information on an operating noise emitted by the motor vehicle, an information on an operating location of the motor vehicle, and/or an information on an operating time of the motor vehicle.

9. The method according to claim 1, wherein the information on the operation of the internal combustion engine comprises an information on a speed of the internal combustion engine, an information on a torque output by the internal combustion engine, and/or an information on a power output by the internal combustion engine.

10. The method according to claim 1, wherein different types of information on the operation of the motor vehicle and/or different types of information on the environment of the motor vehicle each have a priority value assigned thereto, so that when information is acquired that is inconsistent with regard to the operating mode to be selected of the active sound generating device, the operating mode is always selected on the basis of that information that has the higher priority value.

11. An exhaust system for a motor vehicle, comprising:
at least one exhaust pipe carrying exhaust gas;
an active sound generating device configured to generate sound waves that interact with the exhaust gas carried in the at least one exhaust pipe,
the active sound generating device having at least two different operating modes,
the active sound generating device including a drive interface, via which the active sound generating device is connectable, in terms of signaling, to a control unit of a drive engine of the motor vehicle,
the active sound generating device including an environment interface, via which the active sound generating device is directly or indirectly connectable, in terms of signaling, to at least one sensor which detects an environment of the motor vehicle, and
an operating mode of the active sound generating device being selectable by a control unit of the active sound generating device taking into account a signal provided at the drive interface and/or the environment interface; and a display device provided for a driver of the motor vehicle, on which a currently selected or a future operating mode of the active sound generating device and/or a characteristic value associated with the currently selected or future operating mode of the active sound generating device is/are displayable.

12. The exhaust system according to claim 11, wherein a communication interface is provided, via which an information on a state of the motor vehicle, in particular on the selected operating mode, can be transmitted to a unit external to the motor vehicle, in particular an infrastructure unit, and/or via which a limit value information can be transferred from the unit external to the motor vehicle, in particular an infrastructure unit, to the motor vehicle.

13. The exhaust system according to claim 11, wherein a limit value information transferred to the motor vehicle from the unit external to the motor vehicle and/or an information derived therefrom is/are displayable on the display device for the driver.

14. The exhaust system according to claim 11, wherein an input device is provided by which preferences in regard to the selection of the operating mode can be entered, in particular wherein the display device and the input device are realized as one single, combined device.

15. The exhaust system according to any of claim 11, wherein a camera is coupled to the environment interface in terms of signaling, and the information on the environment of the motor vehicle is detectable by the camera.

16. The exhaust system according to claim 11, wherein the active sound generating device is in the form of an active sound damper, a sound generator, or a combination thereof.

17. A motor vehicle comprising an internal combustion engine which is coupled to the exhaust system according to claim 11.

18. A method of selecting an operating mode of an active sound generating device of an exhaust system for a motor vehicle, the exhaust system comprising at least one exhaust pipe carrying exhaust gas and an active sound generating device configured to generate sound waves that interact with the exhaust gas carried in the exhaust pipe, comprising the steps of including:
(a) acquiring an information on the operation of the motor vehicle, in particular on the operation of the internal combustion engine of the motor vehicle, and/or acquiring the information on the environment of the motor vehicle;
(b) selecting one of at least two predefined operating modes of the active sound generating device on the basis of the information acquired in step (a); and
(c) communicating with a unit external to the motor vehicle, in particular an infrastructure unit, wherein an information on a state of the motor vehicle, in particular on the selected operating mode of the active sound generating device, is transmitted to the unit external to the motor vehicle, and/or a limit value information is transferred to the motor vehicle from the unit external to the motor vehicle.
